(19) United States
(12) Patent Application Publication
(10) Pub. No.: US 2006/0135891 A1
(43) Pub. Date: Jun. 22, 2006

(54) Apparatus for treating a person's skin

(75) Inventors: Hermann Jordan, Maria Saal (AT); Ingo Mueller, Klagenfurt (AT); Gert Samonigg, Wolfsberg (AT); Joachim Schrettlinger, Trebesing (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/514,595

(22) PCT Filed: May 7, 2003
(86) PCT No.: PCT/IB03/01917

§ 371 Date: Nov. 16, 2004

(30) Foreign Application Priority Data
May 21, 2002 (EP) 02100544.2

(51) Int. Cl. A61H 1/02

(52) U.S. Cl. 601/20

(57) ABSTRACT

An apparatus (1) for treating a person's skin comprises a motor-driven skin treatment device (2), preferably formed by a brush (2), which device (2) can be driven into rotation and can additionally be driven into vibration, in particular at a frequency lying in a frequency range of between 100 Hz and 140 Hz, a nominal frequency of 120 Hz proving to be particularly advantageous.

The invention relates to an apparatus for treating a person's skin, which apparatus comprises a skin treatment device for achieving a skin treatment effect, which skin treatment device can be motor-driven and comprises a tool support and at least one tool projecting from the tool support for cooperating with the skin, wherein at least one drive part is provided for driving the skin treatment device into rotation about an axis of rotation.

An apparatus of the kind mentioned in the opening paragraph is known from the patent document WO 02/05681 A2. The skin treatment device in the known apparatus is formed by a brush which can be driven into rotation and by means of which a brushing action is generated, such that a skin region under treatment is cleaned. The movement of the tufts of the brush over the relevant skin region caused by the brush rotation substantially only causes a brushing effect and a cleaning effect.

The invention has for its object to improve an apparatus of the kind mentioned in the opening paragraph.

To achieve the above object, features according to the invention are provided in an apparatus according to the invention such that an apparatus according to the invention can be characterized as follows.

An apparatus for treating a person's skin, which apparatus comprises a skin treatment device for achieving a skin treatment effect, which skin treatment device can be motor-driven and comprises a tool support and at least one tool projecting from the tool support for cooperating with the skin, wherein at least one drive part is provided for driving the skin treatment device into rotation about an axis of rotation, and wherein drive means are provided for driving the skin treatment device into vibration, and wherein the skin treatment device can be made to vibrate by the drive means with a frequency lying in a frequency range of between 100 Hz and 140 Hz.

The provision of the features according to the invention result in an improved apparatus for treating a person's skin because the vibratory drive causes the at least one tool of the skin treatment device to perform an additional vibratory movement, the particular feature of this vibratory movement being that this vibratory movement takes place with a frequency substantially corresponding to the mechanical natural frequency of the skin. Intensive research was carried out during the development of the apparatus according to the invention for a longer period, during which it was ascertained that a human skin has a mechanical natural frequency lying in a region around 120 Hz. The vibratory drive of the skin treatment device with a frequency in the range of the natural frequency of the skin in fact achieves that the skin is made to vibrate as it were with its natural resonance frequency by the skin treatment device, with the result that a very good massaging effect is achieved in addition to the skin treatment effect caused by the rotation of the skin treatment device. An additional advantage of the vibratory drive in the frequency range between 100 Hz and 140 Hz is that the skin treatment device driven not only into rotation but also into vibration generates a pleasurable sensation in the person utilizing the apparatus.

It was found to be very advantageous in an apparatus according to the invention if the skin treatment device can be set into vibration by the drive means with a frequency lying in a frequency range of between 115 Hz and 125 Hz, and in particular with a frequency of 120 Hz. These values were found to be particularly advantageous during experiments carried out in the development of the apparatus according to the invention.

It was furthermore found to be very advantageous in an apparatus according to the invention if the skin treatment device, when not cooperating with the skin, can be made to vibrate with a stroke, measured substantially parallel to the axis of rotation, which lies in a stroke range of between 0.2 mm and 1.0 mm. The realization of a stroke in the stroke range indicated is advantageous for achieving a particularly good treatment, for example a cleaning of the skin to be treated. It was indeed found that a vibration with a comparatively large stroke is perceived as unpleasant by many people. It was accordingly found to be particularly advantageous if the skin treatment device, when not cooperating with the skin, can be made to rotate by the drive means with a stroke, measured substantially parallel to the axis of rotation, which lies in a stroke range of between 0.2 mm and 0.4 mm. A particularly good compromise is achieved thereby between a good treatment effect, for example cleaning effect, and a good massaging effect, as well as a pleasant massaging sensation.

It was further found to be advantageous in an apparatus according to the invention if the skin treatment device has its bearings on a carrier for apparatus parts of the apparatus, and the carrier can be set into vibration by the drive means. Such a construction is advantageous for achieving a mechanically stable solution and for realizing of the vibratory movement in a simple manner.

It was further found to be advantageous for such an apparatus with a skin treatment device supported on a carrier if a motor for driving the skin treatment device is fastened to the carrier, and a shaft that can be driven by the motor is supported with rotation possibility by the carrier, and an eccentric configuration is provided on said shaft by means of which the carrier can be set into vibration. Such a construction is particularly advantageous for achieving a solution which is constructionally as simple as possible. Furthermore, this construction has the advantage that the generation of the vibrations by the eccentric configuration can take place in the immediate vicinity of the skin treatment device supported by the carrier and is accordingly very effective.

Furthermore, it was found to be very advantageous in an apparatus according to the invention as described above if in addition the features of claim 8 are provided. This achieves the major advantage that a choice can be made between two different modes of operation in a simple manner, i.e. between a first mode in which the skin treatment device is driven both into rotation and into vibration, and a second mode in which the skin treatment device is driven into rotation only.

In an apparatus according to the invention as described above, the pivoting of the second eccentric piece with respect to the first eccentric piece may take place, for example, electromagnetically. It was found to be particularly advantageous, however, if in addition the features of claim 9 are provided. This achieves the major advantage that the switch-over between the two different modes of operation is made possible in a simple manner through switching-over of the sense of rotation of the motor.

It was found to be advantageous in an apparatus according to the invention, furthermore, if the skin treatment device can be made to rotate by the at least one drive part with a speed lying in a speed range of between 200 and 300 rpm, while it was found to be particularly advantageous if the skin treatment device can be made to rotate with a speed of 320 rpm. Such an rpm value was found to be particularly favorable in combination with the superimposed vibratory movement with a frequency corresponding at least substantially to the natural frequency of the human skin.

It was found to be particularly advantageous in an apparatus according to the invention if the skin treatment device is formed by a motor-driven brush for generating a brushing effect on the skin, which brush comprises a brush support as the tool support and tufts projecting from the brush support as its tools. It is achieved thereby that a brushing effect and an additional massaging effect can be exerted on a skin region simultaneously, so that a particularly good cleaning effect is achieved.

The above and further aspects of the invention will become apparent from the ensuing description of an embodiment and are clarified with reference to this embodiment.

The invention will be explained in more detail below with reference to an embodiment shown in the drawings, to which, however, the invention is not limited.

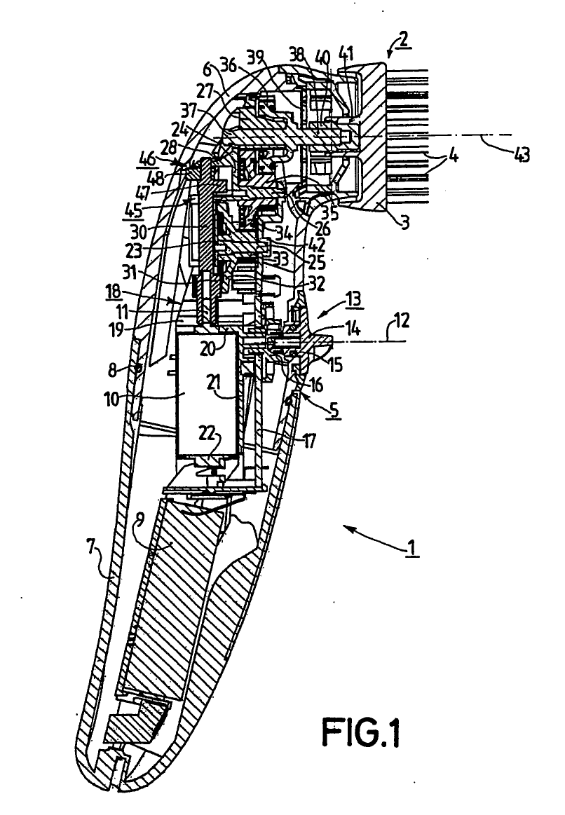

FIG. 1 shows an apparatus according to an embodiment of the invention, comprising an eccentric configuration with two eccentric pieces, in cross-section.

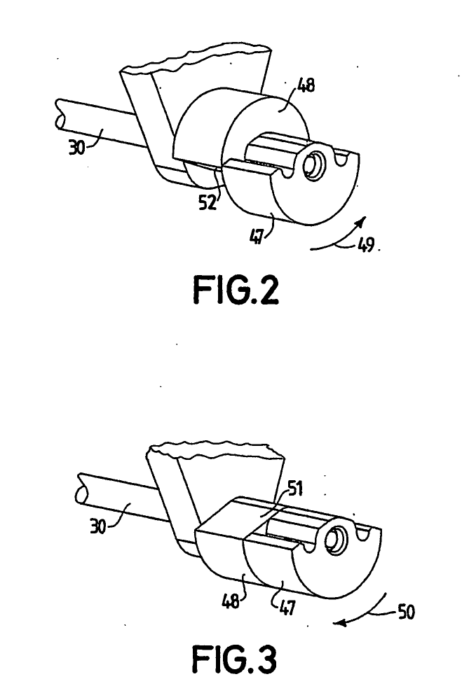

FIG. 2 is an oblique elevation of an eccentric configuration which may be used as an alternative in the apparatus of FIG. 1 and which also comprises two eccentric pieces, said two eccentric pieces occupying a first possible relative position with respect to one another.

FIG. 3 shows in the same manner as FIG. 2 the eccentric configuration of FIG. 2, with the two eccentric pieces occupying a second possible relative position with respect to one another.

FIG. 1 shows an apparatus 1 for treating a person's skin. The apparatus 1 comprises a skin treatment device 2 which is formed here by a motor-driven brush 2, which brush comprises as its tool support 3 a brush support 3 and tufts 4 projecting from the brush support 3 as its tools 4. Means are provided in the apparatus 1 for driving the brush 2 both into rotation and into vibration in a particularly favorable manner. The means for driving the brush 2 into rotation and vibration will be discussed in more detail below.

The apparatus 1 comprises a housing 5, which housing 5 is of a watertight construction. The housing 5 consists of an angled tubular head part 6 and an also tubular base part 7 connected to the head part 6. A seal 8 is provided in the transition region between the head part 6 and the base part 7. A battery 9 is accommodated in the base part 7. The battery 9 is a rechargeable battery 9 in the present case. The battery 9 is provided for powering a motor 10 which is arranged in the transitional region between the head part 6 and the base part 7. The motor 10 has a motor shaft which can be driven in two mutually opposed directions of rotation.

A rotary switch 13 rotating about an axis 12 is provided in the head part region 6 of the housing 5 adjacent to the base part 7. The rotary switch 13 has a rotary knob 14 which is supported with rotation possibility in the head part 6 of the housing 5, while a seal 15 is provided between the rotary knob 14 and the head part 6. The rotary switch 13 further comprises a switching mechanism 16 which is provided on a printed circuit board 17 and which is supported with rotation possibility about the axis 12 with respect to the printed circuit board 17. A supply circuit (not shown in FIG. 1) for supplying the motor 10 is provided on the printed circuit board 17. The supply circuit (not shown) for the motor 10 can be influenced by the rotary switch 13 so as to supply the motor 10 in different manners. The construction is such in the present case that a total of three different modes of operation can be switched by means of the rotary switch 13 of the apparatus 1.

The rotary switch 13 can be rotated between a total of four switching positions, such that the rotary switch can be moved from an idle position in anti-clockwise direction into a first switching position, and from the idle position in clockwise direction into a second switching position, and from the second switching position in clockwise direction further into a third switching position. The apparatus 1, i.e. the motor 10 thereof, is switched off in the idle position. In the first switching position, a first mode of operation is activated in which the motor shaft 11 of the motor 10 is driven in a first direction of rotation, in which case the brush 2 is driven into rotation only, with a nominal speed of 270 rpm. In the second switching position of the rotary switch 13, a second mode of operation is activated in which the motor shaft 11 is driven in a second direction opposed to the first direction of rotation, in which case the brush 2 is driven into rotation and into vibration. The speed of the motor shaft 11 is chosen in the second mode of operation such that the brush 2 is driven at a nominal speed of 190 rpm and a nominal vibration frequency of 80 Hz. In the third switching position of the rotary switch 13, a third mode of operation is activated in which the motor shaft 11 is again driven in the second direction of rotation, in which case the brush 2 is again driven into rotation and additionally also into vibration. In the third mode of operation, the speed of the motor shaft 11 is chosen such that the brush 2 is driven at a nominal speed of 270 rpm and a nominal vibration frequency of 120 Hz. The first mode of operation, which is essentially designed for removing make-up by means of the brush 2, is set in that the rotary switch 13 is moved into its first switching position. Rotating the rotary switch 13 into its second switching position switches on the second mode of operation, which is mainly designed for a gentle, non-abrasive daily cleaning of a user's facial skin by means of the brush 2. The third mode of operation can be switched on through rotating of the rotary switch 13 into its third switching position, which is provided mainly for scrubbing off the upper layer of the skin of a user's face by means of the brush 2, which scrubbing is also denoted “exfoliation” in professional circles.

As is apparent from the above descriptions, the brush 2 provided as the skin treatment device 2 is designed for generating a skin treatment effect, such that different skin treatment effects can be achieved in dependence on the mode of operation of the tufts provided for cooperating with the skin.

A carrier 18 in the form of a frame or chassis is provided in the interior of the housing 5. The carrier 18 is designed for supporting a plurality of apparatus parts of the apparatus 1, which will be discussed in more detail below. The motor 10 is also fastened to the carrier 18, such that the motor 10 is arranged between two side walls 19 of the carrier 18, of which only one side wall 19 is visible in FIG. 1, and three wall portions 20, 21, and 22. Two transverse walls 23 and 24 are also present between the two side walls 19. A first journal 25 integrally connected to the first transverse wall 23 projects from the first transverse wall 23. A second journal 26 integrally connected to the second transverse wall 24 projects from this second transverse wall 24. A first bearing block 27 is integrally connected to the second transverse wall 24, furthermore, which first bearing block 27 is additionally also connected to the two side walls 19. Furthermore, a second bearing block 28 projects from the second transverse wall 24.

A shaft 30 is fixedly connected to the motor shaft 11. The shaft 30 is supported with rotation possibility in the second bearing block 28 at its end facing away from the motor 10. A pinion 31 is integrally connected to the shaft 30. The pinion 31 is in engagement with a contrate gear 32 which has its rotary support on the first journal 25. The contrate gear 32 engages coaxially with a first intermediate gear 33. The first intermediate gear 33 engages with a second intermediate gear 34, which has its rotary support on the second journal 26. The second intermediate gear 34 is integrally, coaxially connected to a third intermediate gear 35. A closing gear 36 is in engagement with the third intermediate gear 35. The closing gear 36 is bell-shaped and is integrally connected to a bearing shaft 37. The bearing shaft 37 is supported with rotation possibility in the first bearing block 27. A shaft portion 38 of the bearing shaft 37 facing away from the bearing block 27 is passed through a seal 39. A coupling piece 40 is fixedly pressed onto the free end of the bearing portion 38. The coupling piece 40 is provided and constructed for detachably holding the brush 2, the construction being chosen such that a detachable locking connection is formed between a sleeve portion 41 of the brush 2 and the coupling piece 40. It should be noted that a cover 42 is placed over the first journal 25 and the second journal 26, which cover is fixedly connected to the carrier 18 and by means of which cover both the first journal 25 and the second journal 26 as well as the gears supported thereon are retained in their operational positions. The pinion 31 and the contrate gear 32 and the three intermediate gears 33, 34, 35 and the closing gear 36 form a drive transmission construction for driving the brush 2 into rotation with respect to an axis of rotation 43 defined by the axis of the bearing shaft 37. As is apparent from the description given above, the brush 2 is supported on the carrier 18 of the apparatus 1 by means of the bearing shaft 37 and the first bearing block 27.

The apparatus 1 highly advantageously comprises additional drive means 45 for driving the skin treatment device 2, i.e. the brush 2, into vibration. The drive means 45 comprise also the motor 10 and the motor shaft 11 and the shaft 30 which can be driven into rotation by the motor shaft 11 and which is supported with rotation possibility by the carrier 18, i.e. directly with its free end in the second bearing block 28 and indirectly by means of the motor shaft 11 and the motor 10 fastened to the carrier 18. The drive means 45 further comprise an eccentric configuration 46 provided on the shaft 30, by means of which the entire carrier 18 can be made to vibrate in the embodiment shown here. Since the carrier 18 in the present embodiment is directly connected to the housing 5 of the apparatus 1, the housing 5 is also made to vibrate by the carrier 18, i.e. in particular in that region in which the eccentric configuration 46 is positioned. It should be noted here that the carrier 18 in an alternative constructional embodiment may be held in the housing 5 with interposed rubber-type dampers, in which case practically no vibration transmission from the carrier 18 to the housing 5 will be present.

It should be noted on the eccentric configuration 46 in the apparatus of FIG. 1 that the eccentric configuration 46 in principle has the same construction as the eccentric configuration 46 shown in FIGS. 2 and 3, which is why the two eccentric configurations 46 of FIG. 1 on the one hand and of FIGS. 2 and 3 on the other hand will be jointly described below.

The eccentric configuration 46 comprises a first eccentric piece 47 fixedly connected to the shaft 30 and a second eccentric piece 48 passed over the shaft 30 and pivotably supported on the shaft 30. In the first direction of rotation of the shaft 30 in accordance with an arrow 49 in FIG. 2, the two eccentric pieces 47 and 48 occupy relative positions such that no eccentric action takes place. This is achieved in that the two eccentric pieces 47 and 48 have mutually attuned constructions as regards the masses of these two eccentric pieces 47 and 48. In the second direction of rotation of the shaft 30 opposed to the first direction of rotation 49 and indicated by arrow 50 in FIG. 3, the two eccentric pieces 47 and 48 will occupy relative positions such that an eccentric action occurs, i.e. because the two eccentric pieces 47 and 48 lie substantially flush with one another in the direction of the shaft 30. The respective relative positions of the two eccentric pieces 47 and 48, or in other words the position of the second eccentric piece 48 with respect to the first eccentric piece 47, is realized by means of a projection not visible in FIGS. 1 to 3, which projection is integrally connected to the first eccentric piece 47 and which extends from the first eccentric piece 47 in the direction of the shaft 30 into the path of movement of the second eccentric piece 48. The result of this is that the second eccentric piece 48 hits the projection (not visible in the Figures) of the first eccentric piece 47 either with a first abutment 51 or with a second abutment 52, depending on the sense of rotation of the shaft 30.

The apparatus 1 is constructed such that the brush 2 provided as the skin treatment device 2 in its third mode of operation is made to vibrate at a nominal frequency of 120 Hz by the drive means 45, i.e. by the motor 10, the shaft 30, and the eccentric configuration 46. It should be noted here that the vibrations generated in the apparatus 1 do not occur in one direction, but that a diffuse vibration behavior occurs without preferred directions. The apparatus 1 is furthermore constructed such that the brush 2, when co-operating with a human skin, is set into vibration by the drive means 45 in the third mode of operation with a stroke, measured parallel to the axis of rotation 43, which lies in a stroke range of between 0.2 mm and 0.4 mm, and preferably with a stroke of nominally 0.3 mm. The apparatus 1 is furthermore constructed such that the brush 2 in the third mode of operation can be made to rotate by means of the pinion 31 and the intermediate gears 33, 34, 35 and the closing gear 36 at a nominal speed of 270 rpm.

It was found to be particularly advantageous with the apparatus 1 in the third mode of operation that the brush 2 is driven at a nominal frequency of 120 Hz, and that it performs a stroke of nominally 0.3 mm in the unloaded state, i.e. in the contactless state, and is driven during this at a nominal speed of 270 rpm. The additional vibratory drive of the brush 2 at a nominal frequency of 120 Hz in fact achieves that the brush is driven with a frequency corresponding to the mechanical natural frequency of the human skin, with the result that the brush 2 makes the skin vibrate in a natural resonance mode, so that the brushing effect caused by the rotation of the brush 2 is supplemented with a very good massaging effect.

It should be noted that the vibration frequency need not necessarily be at nominally 120 Hz, but may lie in a frequency range of between 100 Hz and 140 Hz, for which it was found to be advantageous in a modification of the apparatus of FIG. 1 to provide means by which the vibration frequency can be changed or set, which renders it possible to adapt the actually realized vibration frequency to different skin characteristics and thus to different mechanical natural frequencies of the skins of different individuals.

The amplitude of the vibrations, i.e. the stroke of the brush 2 in the direction of the axis of rotation 43 during the generation of the vibrations in the apparatus 1 of FIG. 1, is given by the mechanical properties of the eccentric configuration 46 and also by the mechanical properties of the components of the apparatus 1, in particular the carrier 18, set into vibration by the eccentric configuration 46. It is possible by means of a modified construction, for example by means of an elastic support of the carrier 18, to achieve a greater vibration stroke of, for example, 0.6 mm or 1.0 mm.

A solution may alternatively be provided in which the bearing shaft 37 is made to vibrate directly by means of an eccentric device, i.e. by means of an eccentric device provided between the motor shaft and the bearing shaft 37 for the brush 2, in which case said vibrations will take place exactly in the direction of the bearing shaft 37 and accordingly in the direction of the axis of rotation 43.

In the apparatus 1 of FIG. 1, the rotary movement and the vibratory movement of the brush 2 are realized by a single motor, with the result that the speed of rotation of the brush 2 and the vibration frequency of the brush 2 cannot be independently chosen or realized. Such a mutually independent realization of the speed of rotation and of the vibration frequency of the brush 2, or some other skin treatment device, is possible if an apparatus according to the invention is fitted with two mutually independent motors.

The brush support 3 of the brush 2 of the apparatus 1 of FIG. 1 has a planar boundary surface from which the tufts 4 project perpendicularly. This need not necessarily be the case, because the brush support 3 may alternatively have a concave or convex boundary surface and because the tufts may also project from a boundary surface of a brush support 3 in a diverging or converging manner.

It should further be noted that, instead of a brush 2 serving as the skin treatment device 2, alternative skin treatment devices may be provided in an apparatus according to the invention. For example, such a skin treatment device may have a curved basic body on which a cleaning cloth made of cotton is tensioned, often denoted as a cotton pad in the field of cosmetics. Other skin treatment devices, for example foam cushions, are also possible.

1. An apparatus (1) for treating a person's skin, which apparatus (1) comprises a skin treatment device (2) for achieving a skin treatment effect, which skin treatment device (2) can be driven by a motor and comprises a tool support (3) and at least one tool (4) projecting from the tool support (3) for cooperating with the skin, wherein at least one drive part (11, 30, 31, 32, 33, 34, 35, 36, 37, 38, 40) is provided for driving the skin treatment device (2) into rotation about an axis of rotation (43), and wherein drive means (10, 11, 30, 46) are provided for driving the skin treatment device (2) into vibration, and wherein the skin treatment device can be made to vibrate by the drive means (10, 11, 30, 46) with a frequency lying in a frequency range of between 100 Hz and 140 Hz.

2. An apparatus (1) as claimed in claim 1, wherein the skin treatment device (2) can be set into vibration by the drive means (10, 11, 30, 46) with a frequency lying in a frequency range of between 115 Hz and 125 Hz.

3. An apparatus (1) as claimed in claim 2, wherein the skin treatment device (2) can be set into vibration by the drive means (10, 11, 30, 46) with a nominal frequency of 120 Hz.

4. An apparatus (1) as claimed in claim 1, wherein the skin treatment device (2), when not cooperating with the skin, can be made to vibrate by the drive means (10, 11, 30, 46) with a stroke, measured substantially parallel to the axis of rotation (43), which lies in a stroke range of between 0.2 mm and 1.0 mm.

5. An apparatus (1) as claimed in claim 4, wherein the skin treatment device (2), when not cooperating with the skin, can be made to vibrate by the drive means (10, 11, 30, 46) with a stroke, measured substantially parallel to the axis of rotation (43), which lies in a stroke range of between 0.2 mm and 0.4 mm.

6. An apparatus (1) as claimed in claim 1, wherein the skin treatment device (2) has its bearings on a carrier (18) for apparatus parts of the apparatus (1), and said carrier (18) can be set into vibration by the drive means (10, 11, 30, 46).

7. An apparatus (1) as claimed in claim 6, wherein a motor (10) for driving the skin treatment device (2) is fastened on the carrier (18), and a shaft (30) that can be driven by the motor (10) is supported with rotation possibility by the carrier (18), and an eccentric configuration (46) is provided on said shaft (30), by means of which configuration (46) the carrier (18) can be set into vibration.

8. An apparatus (1) as claimed in claim 7, wherein the eccentric configuration (46) comprises a first eccentric piece (47) fixedly connected to the shaft (30) and a second eccentric piece (48) passed over the shaft (30) and pivotably supported on the shaft (30), which second eccentric piece (48) can be brought into two positions relative to the first eccentric piece (47) by means of pivoting, and wherein no eccentric effect occurs when the two eccentric pieces (47, 48) occupy their first relative positions with respect to one another, and wherein an eccentric effect does occur when the two eccentric pieces (47, 48) occupy their second relative positions with respect to one another.

9. An apparatus (1) as claimed in claim 8, wherein the shaft (30) can be driven by the motor (10) in two mutually opposed directions of rotation (49, 50), and wherein the second eccentric piece (48) can be brought into its two relative positions with respect to the first eccentric piece (47) through reversion of the direction of rotation, and wherein in a first direction of rotation (49) of the shaft (30) the two eccentric pieces (47, 48) occupy relative positions with respect to one another such that no eccentric effect occurs, and wherein in a second direction of rotation (50) of the shaft (30) opposed to the first direction of rotation (49) the two eccentric pieces (47, 48) occupy relative positions with respect to one another such that an eccentric effect does occur.

10. An apparatus (1) as claimed in claim 1, wherein the skin treatment device (2) can be made to rotate by the at least one drive part (11, 30, 31, 32, 33, 34, 35, 36, 37, 38, 40) with a speed lying in a speed range of between 200 and 300 rpm.

11. An apparatus (1) as claimed in claim 9, wherein the skin treatment device can be made to rotate by the at least one drive part (11, 30, 31, 32, 33, 34, 35, 36, 37, 38, 40) with a nominal speed of 270 rpm.

12. An apparatus (1) as claimed in claim 1, wherein the skin treatment device (2) is formed by a motor-driven brush (2) for generating a brushing effect on the skin, which brush (2) comprises a brush support (3) as the tool support (3) and tufts (4) projecting from the brush support (3) as its tools (4).
